(19) United States
(12) Patent Application Publication
(10) Pub. No.: US 2016/0288730 A1
(43) Pub. Date: Oct. 6, 2016

(54) Mobile Device Mount for Compact Disc Slot

(71) Applicant: Tone Layout, LLC, East Rutherford, NJ (US)

(72) Inventors: Jong Hyuk LEE, East Rutherford, NJ (US); Dongyeob LEE, Bucheon (KR)

(73) Assignee: Tone Layout, LLC, East Rutherford, NJ (US)

(21) Appl. No.: 14/950,227

(22) Filed: Nov. 24, 2015

(30) Foreign Application Priority Data
Apr. 3, 2015 (KR) 10-2015-0047211

(51) Int. Cl. B60R 11/02; A45F 5/00

(52) U.S. Cl. CPC B60R 11/02; A45F 5/00; F16B 2001/0035

(57) ABSTRACT

A holder for a portable device includes a mounting member having a mount body with a first holding arm opposite a second holding arm. A support rod assembly is coupled to the first holding arm. A first biasing member is coupled to the support rod assembly on one end and a support shaft on an opposite end such that the first holding arm is extendable to accommodate portable devices of all sizes. The holder also includes a fixing member having an outer housing with a lower fixing wing extending therefrom. A button body having an upper fixing wing extending therefrom. A second biasing member is coupled to and engages the outer housing and button body such that the upper fixing wing is movable toward the lower fixing wing for engaging a CD slot. The mounting member and fixing member are operably coupled together such that the mounting member is adjustable.

### CROSS REFERENCE TO RELATED APPLICATION

This application claims foreign priority to Korea Patent Application No. 10-2015-0047211, filed on Apr. 3, 2015, which is incorporated by reference in its entirety.

### TECHNICAL FIELD

The present invention relates to a mobile device mount for a compact disc (CD) slot, which is provided with a means for fixing the mobile device mount without directly exerting external force on fixing wings that are inserted into the CD slot in a vehicle to fix the mobile device mount, such that the mobile device mount may be used for a long period of time without causing deformation of the fixing wings.

### BACKGROUND

Recently, with the development of information and communications technology, various types of mobile devices such as mobile phones, tablet PCs, navigation systems, smart phones, personal digital assistants (PDA), portable multimedia players (PMP), and digital video broadcasting (DVB) are proposed.

Because of the nature of the mobile device, a need to use the mobile device in a moving vehicle as well as a fixed location is increased, and as a result, a mount for mounting the mobile device in the vehicle has been developed and used.

As a recently proposed technology, “Multipurpose Mount Attached to Window of Vehicle” (Korean Utility Model Registration No. 376788) has been proposed, and a technical configuration of the multipurpose mount has a structure that allows a space, which is formed between a flat attachment surface such as glass and a bottom surface of an adsorbent plate, to be in a vacuum (i.e., low-pressure) state and attaches the mount, but the multipurpose mount has a problem in that the multipurpose mount cannot be securely attached because the adsorptive force decreases as the multipurpose mount is used.

As an alternative to the multipurpose mount, “Cellular Phone Stationary Platform Fixing Device of Car (Korean Patent No. 10-0339911)” has been proposed. The cellular phone stationary platform fixing device of a car in the related art has a structure that mounts the mount using a CD slot in the vehicle, and the platform is fixed to the CD slot by being fitted into the CD slot in the vehicle instead of being fixed through a vacuum compression manner, such that the cellular phone stationary platform fixing device has a good performance in mounting the mobile device because there is almost no change in material of the configuration (portion that is hardened according to the nature of a rubber material) due to the repetitive use, but has a problem in that a structure thereof is complicated.

The problem with the cellular phone stationary platform fixing device of a car in the related art, which has been slightly improved, has been solved by “Universal Mount for Mobile Device” (Korean Utility Model Registration No. 20-0474064) by significantly simplifying a structure that is mounted to the CD slot in the vehicle. FIG. 1 is a perspective view illustrating a partially improved universal mount for a mobile device in the related art, and FIG. 2 is a view illustrating a process of mounting the partially improved universal mount for a mobile device in the related art to a CD slot in a vehicle.

As illustrated, the partially improved universal mount for a mobile device in the related art includes a mounting member 10 into which a mobile device is fitted, and a fixing member 20 which is connected to the mounting member 10 and fitted and fixed to a CD slot in a vehicle.

Here, the fixing member 20 includes a body 21 which is connected to the mounting member 10, a horizontal fixing wing 22 which is connected to a central portion at a rear side of the body 21, and rotary moving wings 23 which are disposed and fixed at both sides of the horizontal fixing wing 22 and inclinedly connected to the horizontal fixing wing 22.

In this case, the pair of rotary moving wings 23 is made of a plastic material having elasticity so as to be bendable by external force transmitted from the outside such as the hand, and manufactured to have a small thickness so as to be more easily bent.

Accordingly, when the partially improved universal mount for a mobile device in the related art is intended to be mounted to the CD slot in the vehicle, the rotary moving wings 23, which are connected to both sides of the body 21 that constitutes the fixing member 20, are brought into contact with and pushed on an entrance end of the CD slot in the vehicle, and as a result, the rotary moving wings 23, which are inclinedly connected to the horizontal fixing wing 22, are horizontally disposed in parallel with the horizontal fixing wing 22, such that the rotary moving wings 23 may enter the CD slot in the vehicle.

Thereafter, when the rotary moving wings 23 and the horizontal fixing wing 22, which have been horizontally disposed in parallel, enter the CD slot in the vehicle, the pair of rotary moving wings 23, which has been bent by external force, is spread while being restored to original positions, such that the rotary moving wings 23 and the horizontal fixing wing 22 are mounted by being caught by a width of the CD slot of the vehicle.

Thereafter, the mobile device is used in a state in which the mobile device is fitted into the mounting member 10.

However, notwithstanding such advantages, the universal mount for a mobile device in the related art has the following problems.

That is, because the universal mount is a type in which the rotary moving wings 23 and the horizontal fixing wing 22 are fitted into the CD slot in a state in which gaps between the rotary moving wings 23 and the horizontal fixing wing 22, which become greater than the width of the CD slot in the vehicle, have been narrowed by applying external force, the rotary moving wings 23 in a spread state need to be elastically bent whenever the universal mount is used. In other words, the rotary moving wings 23 cannot be displaced without applying force directly to outer portions of the rotary moving wings 23.

However, the external force, which is applied to the rotary moving wings 23 when the universal mount is used, is concentrated on connecting portions between the rotary moving wings 23 and the body 21 which are most unstable in terms of energy, and in this case, because the rotary moving wings 23 are made of a plastic material due to the nature of the material that needs to be elastically bent, there is a problem in that hardening of the connecting portions between the rotary moving wings 23 and the body 21 is promoted, and the connecting portions are easily damaged.

The rotary moving wing 23 has a small thickness in order to improve a degree to which the rotary moving wing 23 is bent, which causes a negative effect that further accelerates the above problems.

### SUMMARY OF INVENTION

The preferred embodiments are intended to overcome at least the disadvantages described above. The preferred embodiments are also intended to provide additional advantages which are described in detail below. The following presents a simplified summary in order to provide a basic understanding of some embodiments. This summary is not an extensive overview and is not intended to identify key/critical elements or to delineate the scope of the embodiments. Its sole purpose is to present some embodiments in a simplified form as a prelude to the more detailed description that is presented later.

The present invention has been made in an effort to solve the problems in the related art, and an object of the present invention is to provide a mobile device mount for a CD slot, which is provided with a means for fixing the mobile device mount without directly exerting external force on fixing wings that are inserted into the CD slot in a vehicle to fix the mobile device mount. The present invention also provides a mounting member for securing all types of mobile devices or all sizes.

In one aspect, the present invention provides a holder for a portable device, comprising: a mounting member comprising: a mount body having a first holding arm opposite a second holding arm and an intermediate section therebetween; a support rod assembly having first and second ends, the support rod assembly first end coupled to the first holding arm; a biasing member having first and second ends, the biasing member first end coupled to the support rod assembly second end; and a support shaft coupled to the mount body intermediate section, the biasing member second end coupled to the support shaft.

In another aspect, the present invention provides a holder for a portable device, comprising: a fixing member comprising: an outer housing having upper and lower ends, a space extending between the outer housing upper and lower ends, a lower fixing wing extending from the housing; a button body having upper and lower ends, an upper fixing wing extending from the button body, the upper fixing wing positioned above the lower fixing wing at a first vertical distance in a rested state; and a biasing member, the biasing member coupled to the outer housing; wherein the button body is secured within the outer housing space and the biasing member engages the outer housing and button body.

In yet another aspect, the present invention provides a holder for a portable device comprising: a mounting member comprising: a mount body having an first holding arm opposite a second holding arm and an intermediate section therebetween; a support rod assembly having first and second ends, the support rod assembly first end coupled to the first holding arm; a first biasing member having first and second ends, the first biasing member first end coupled to the support rod assembly second end; and a support shaft coupled to the mount body intermediate section, the first biasing member second end coupled to the support shaft; and a first attachment member extending from a rear portion of the mount body; and a fixing member comprising: an outer housing having upper and lower ends, a space extending between the outer housing upper and lower ends, a lower fixing wing extending from the outer housing; a button body having upper and lower ends, an upper fixing wing extending from the button body, the upper fixing wing positioned above the lower fixing wing at a first vertical distance in a rested state; a second biasing member, the second biasing member coupled to the outer housing, wherein the button body is secured within the outer housing space and the second biasing member engages the outer housing and button body; and a second attachment member extending from a front portion of the outer housing; wherein the first and second attachment members are engaged such that mounting member and fixing member are operably coupled together.

The present invention has an effect in that the mobile device mount is provided with a means for fixing the mobile device mount without directly exerting external force on fixing wings that are inserted into the CD slot in a vehicle to fix the mobile device mount, such that the mobile device mount may be used for a long period of time without causing deformation of the fixing wings. The present invention also provides a mounting member for securing all types of mobile devices or all sizes.

### BRIEF DESCRIPTION OF THE FIGURES

The foregoing summary, as well as the following detailed description of presently preferred embodiments, will be better understood when read in conjunction with the appended drawings. For the purpose of illustrating the embodiments, there are shown in the drawings embodiments which are presently preferred. It should be understood, however, that the embodiments are not limited to the precise arrangements and instrumentalities shown.

This invention is illustrated in the accompanying drawings. The embodiments herein will be better understood from the following description with reference to the drawings, in which:

FIG. 1 is a perspective view illustrating a universal mount for a mobile device in the prior art;

FIG. 2 is a view illustrating a process of mounting the universal mount for a mobile device of FIG. 1 to a CD slot in a vehicle;

FIG. 3 is a perspective view illustrating an embodiment of a mobile device mount for a CD slot according to the present invention;

FIG. 4 is an exploded perspective view of a main part of a fixing member of the mobile device mount of FIG. 3, which is one of the constituent elements that constitute the mobile device mount for a CD slot according to the present invention;

FIG. 5 is a vertical cross-sectional view of a main part of the fixing member of FIG. 4, which is one of the constituent elements that constitute the mobile device mount for a CD slot according to the present invention;

FIG. 6 is a horizontal cross-sectional view of a main part of the fixing member of FIG. 4, which is one of the constituent elements that constitute the mobile device mount for a CD slot according to the present invention;

FIG. 7 is an exploded perspective view of a main part of a mobile device mounting member of the mobile device mount of FIG. 3, which is one of the constituent elements that constitute the mobile device mount for a CD slot according to the present invention;

FIG. 8 is a vertical cross-sectional view of a main part of the mobile device mounting member of FIG. 7, which is one of the constituent elements that constitute the mobile device mount for a CD slot according to the present invention;

FIG. 9 includes vertical cross-sectional views of the fixing member of the mobile device mount of FIG. 3 in a rested state, partially engaged state and an engaged state;

FIG. 10 includes vertical cross-sectional views of the mounting member of the mobile device mount of FIG. 3 illustrating steps in which a mobile device is mounted therein;

FIG. 11 is a top perspective view of another embodiment of a mounting member of a mobile device mount for a CD slot according to the present invention; and

FIG. 12 is a top perspective view of the mounting member of FIG. 3 in a partially assembled state.

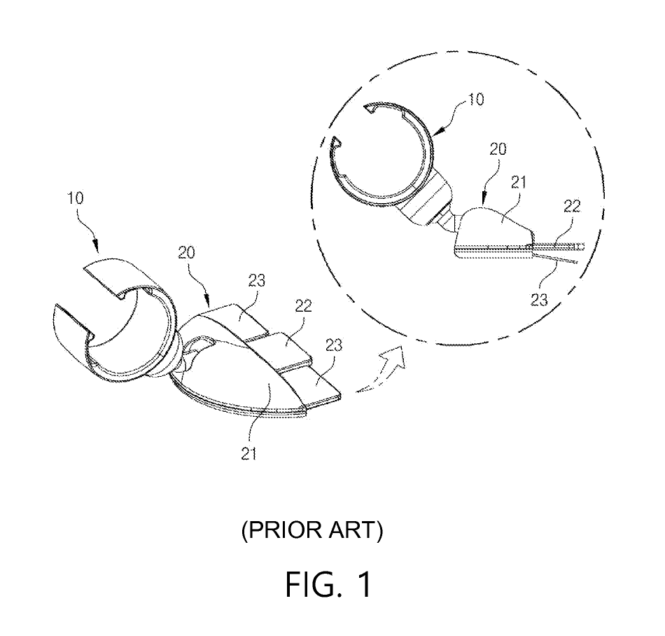

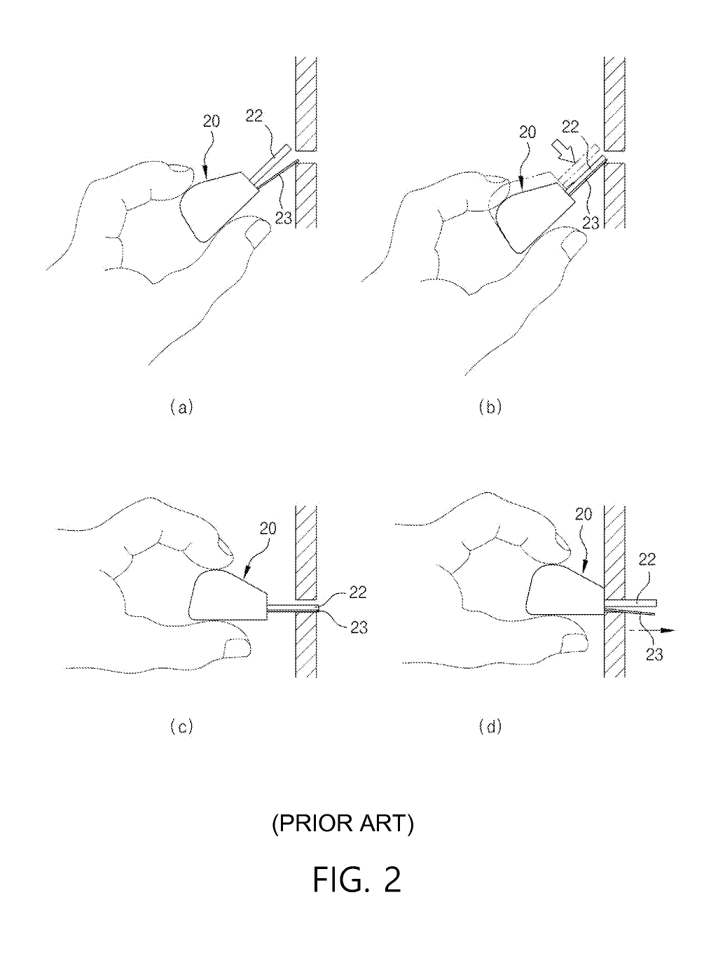

To facilitate an understanding of the embodiments, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF INVENTION

Certain terminology is used in the following description for convenience only and is not limiting. The article “a” is intended to include one or more items, and where only one item is intended the term “one” or similar language is used. Additionally, to assist in the description of the present embodiments, words such as top, bottom, upper, lower, front, rear, inner, outer, right and left are used to describe the accompanying figures only. The terminology includes the words above specifically mentioned, derivatives thereof, and words of similar import, and are not intended to limit the scope of the invention.

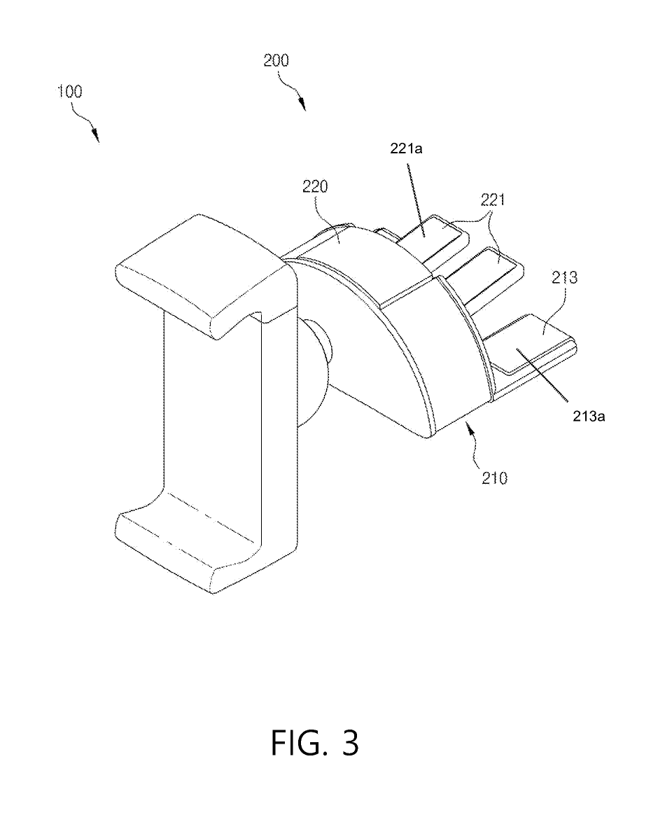

As illustrated in FIG. 3, a mobile device mount or a holder for a portable device for a CD slot of a vehicle according to the present invention broadly includes a universal mobile device mounting member 100, and a fixing member 200 for a CD slot.

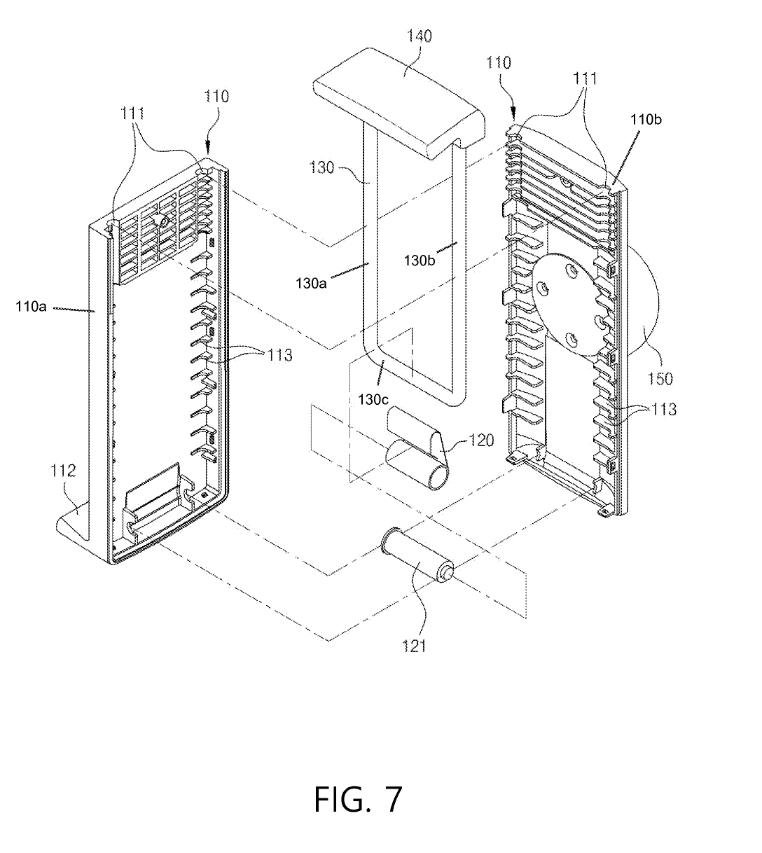

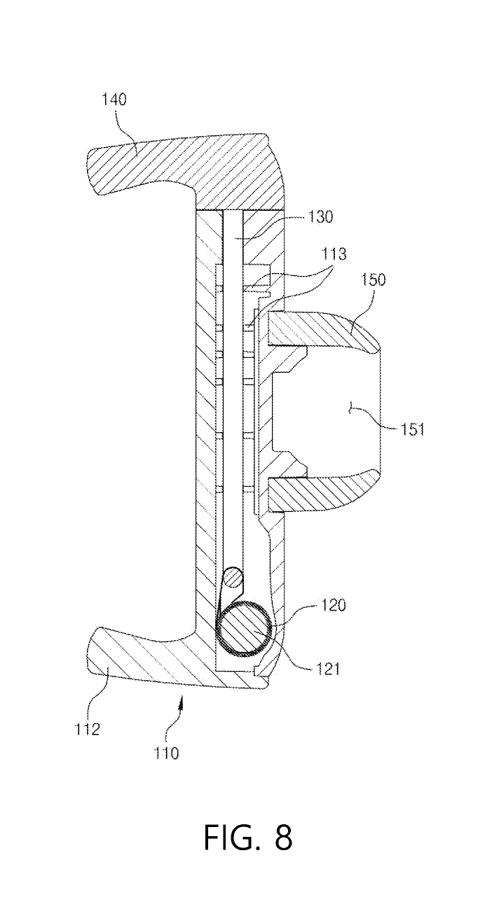

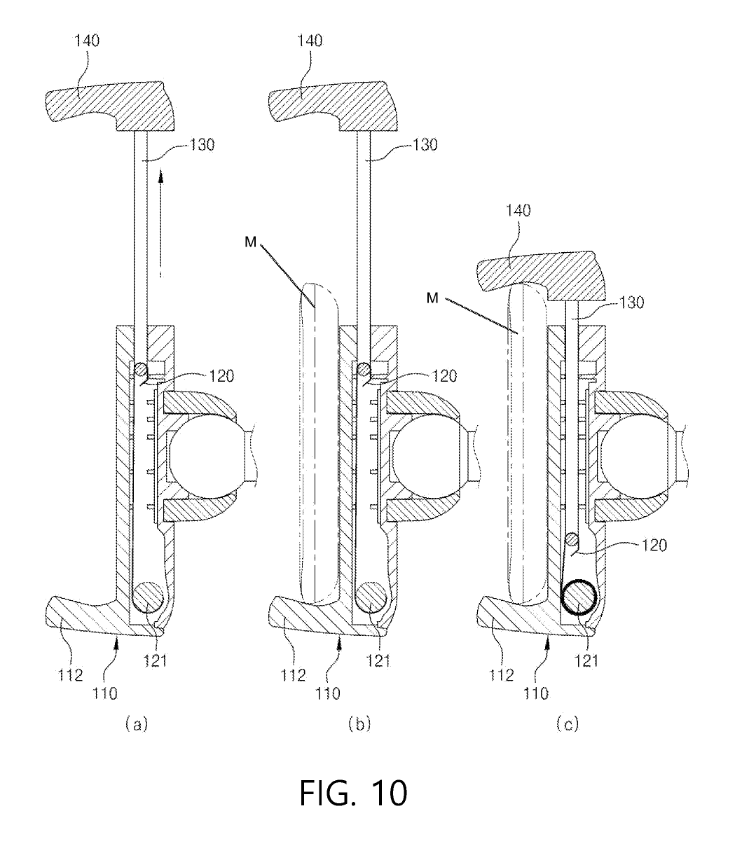

Referring to FIGS. 7, 8, 10 and 12, the mobile device mounting member 100 is a member for fixing a mobile device M (see FIG. 10), and serves to prevent the mobile device M from being biased to one side when the mobile device M is mounted to the mobile device mounting member 100, and to minimize deterioration in mounting efficiency even though external impact is transmitted while the vehicle travels.

Referring again to FIGS. 7, 8, 10 and 12, a detailed configuration of the mobile device mounting member 100, which performs the above functions, includes a mount body 110 which has through holes 111 at a first end thereof. A second holding arm 112 protrudes from a lower end thereof on which a lower portion of the mobile device M is placed.

Referring to the same figures, a first biasing member 120 which is connected and installed to a support shaft 121 that is connected in the mount body 110. In this embodiment, the first biasing member 120 is a roll of thin metal film. The metal film is sufficiently flexible so that the roll could be extended and retracted but also durable so that the metal film will not deform with repeated extending and retracting. The roll of metal film need not be fixed to the support shaft 121. Instead, the support shaft 121 is simply positioned within the roll such that the metal film roll could freely rotate about the support shaft 121.

Referring to the same figures, the mounting member 100 includes a support rod assembly 130 which supports the first biasing member 120 at an opposing end. The support rod assembly 130 includes a first end and a second end. The support rod assembly 130 includes a pair of longitudinal rods 130a, 130b, which are fixed to a first holding arm 140. The support rod 130 second end includes a transverse rod 130c which couples the pair of longitudinal rods 130a, 130b. The first biasing member 120 is secured to the transverse rod 130c. In this embodiment, the metal film 120 is looped around the transverse rod 130c and the looped portions of the metal film 120 are welded together but other methods could be used such as securing the loops portions with a fastener or the like. As an alternative, the transverse rod 130c could include a slit and the metal film 120 could be inserted and secured therein.

In this embodiment, the first biasing member 120 is preferably stainless steel, but other metals could be used. The first biasing member 120 could take on other forms as well. For example, a conventional spring could be used to bias the first holding arm 140 against an intermediate portion of the mount body 110. The first biasing member 120 could also be constructed of a flexible yet durable metal sheet folded into an accordion-like configuration for expanding and contracting to engaged and rested states, respectively, of the mounting member 100.

Referring again to the same figures, the longitudinal rods 130a, 130b are exposed through the through holes 111 of the mount body 110, and guides the mobile device M so that the mobile device M is engaged with the first holding arm 140 by the force of the biasing member 120.

Referring to FIGS. 7 and 12, the mount body 110 includes a front shell 110a and a rear shell 110b, which could be secured together by fastener. The front and rear shells 110a, 110b, could also be secured by snap-fit configuration. Guide wings 113 guide the support rod assembly 130 so that the each longitudinal rod 130a, 130b may be moved from a rested state (FIG. 3) to an engaged state (FIG. 10) in a linear fashion. The guide wings 113 may be installed and provided at predetermined intervals on inner surfaces of the front and rear shells 110a, 110b.

Referring to FIG. 10, in the mobile device mounting member 100, when the first holding arm 140 is held and then moved away from the second holding arm 112, the biasing member 120 connected to the support rod assembly 130 is elastically extended. Thereafter, when the exerted external force applied to the first holding arm 140 is slowly eliminated in a state in which the lower surface of the mobile device M is placed on the lower fixing projection 112, the elastically extended biasing member 120 is elastically restored to allow the first holding arm 140 to press against the mobile device M, thereby fixing the mobile device M securely to the mobile device mounting member 100 in an engaged state.

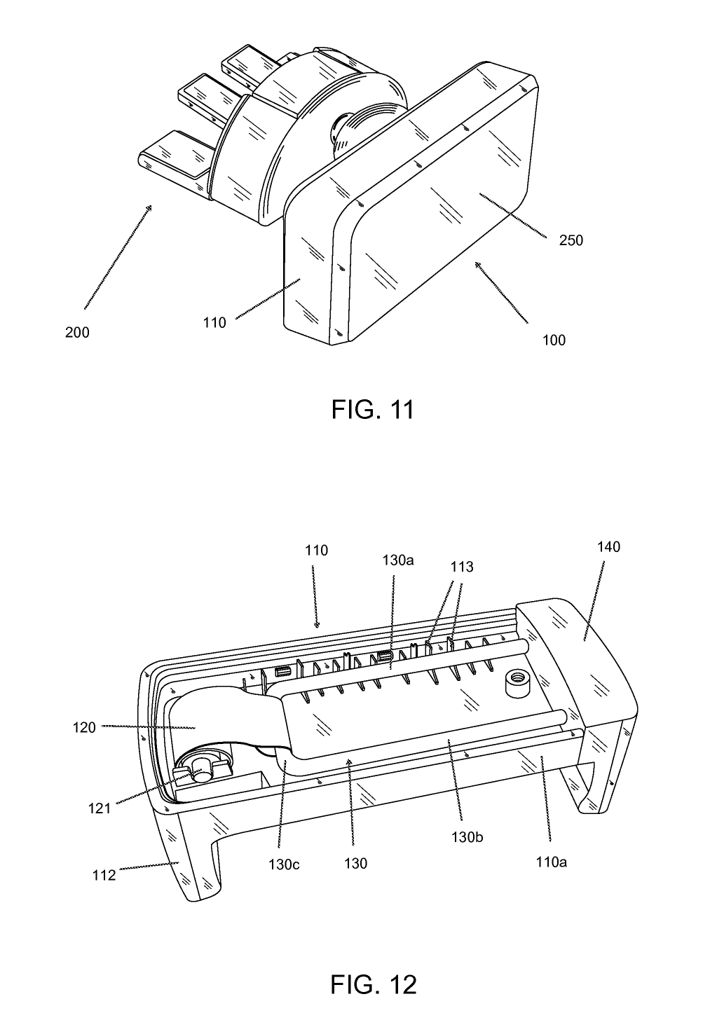

Referring to FIG. 11, another embodiment of the mobile device mounting member 100 includes a mount body 110 with a magnetic surface so that a mobile device M with a ferromagnetic surface (or attachment) may be affixed to the mobile device mounting member 100.

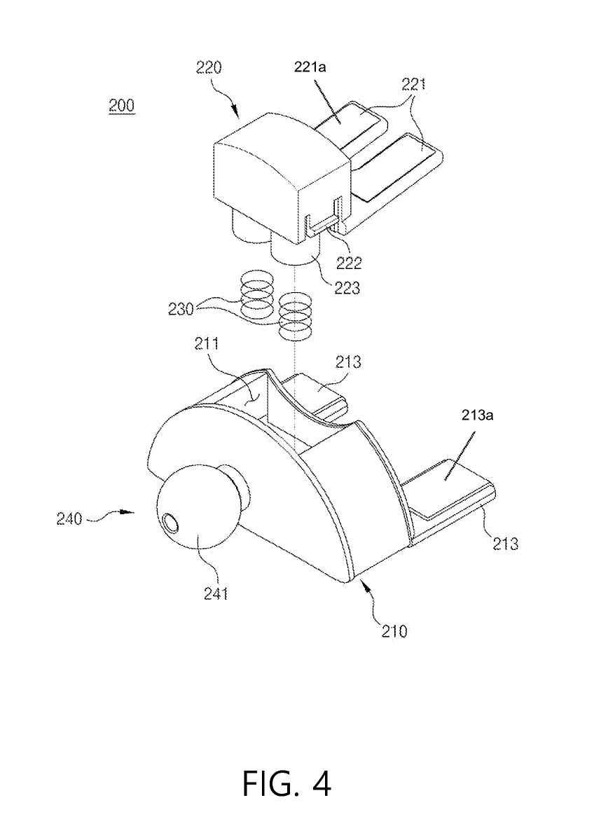

Referring to FIGS. 4-6 and 9, the fixing member 200 for a CD slot is a member which is connected to the mobile device mounting member 100, and controls an upper fixing wing 221 and a lower fixing wing 213 so that a gap I1 between the upper fixing wing 221 and the lower fixing wing 213 is greater than a width W of the CD slot, and controls the upper fixing wing 221 and the lower fixing wing 213 so that a gap 12, which becomes narrowed when the upper fixing wing 221 is moved downward by exerted external force, is smaller than the width W of the CD slot, so as to insert and fix the upper fixing wing 221 and the lower fixing wing 213 into the CD slot.

Referring to the same figures, a detailed configuration of the fixing member 200 for a CD slot, which performs the above functions, includes an outer housing 210 which is opened at an upper side to form a button accommodating space 211, and opened at a back side to form a handling space 212, and has a back side to which the lower fixing wing 213 is connected. A button body 220 is disposed in the button accommodating space 211 of the mounting body 210, and has a protruding tab 222 on each of the left and right side, and has a back side to which the upper fixing wing 221 is connected such that the connected upper fixing wing 221 is exposed through the handling space 212 of the mounting body 210. A second biasing member 230, in this embodiment, a spring, which has a lower side is connected to a bottom of the outer housing 210, and an upper side is connected to a lower surface of the button body 220 so as to transmit elastic restoring force to the button body 220 such that the upper fixing wing 221 of the button body 220 presses and comes into contact with an upper surface that defines the handling space 212 of the mounting body 210. In this embodiment, each of the fixing wings 213, 221 includes a protective pad 213a, 221a for guarding against any damage to the CD slot due to friction between the fixing wings 213, 221 and the CD slot.

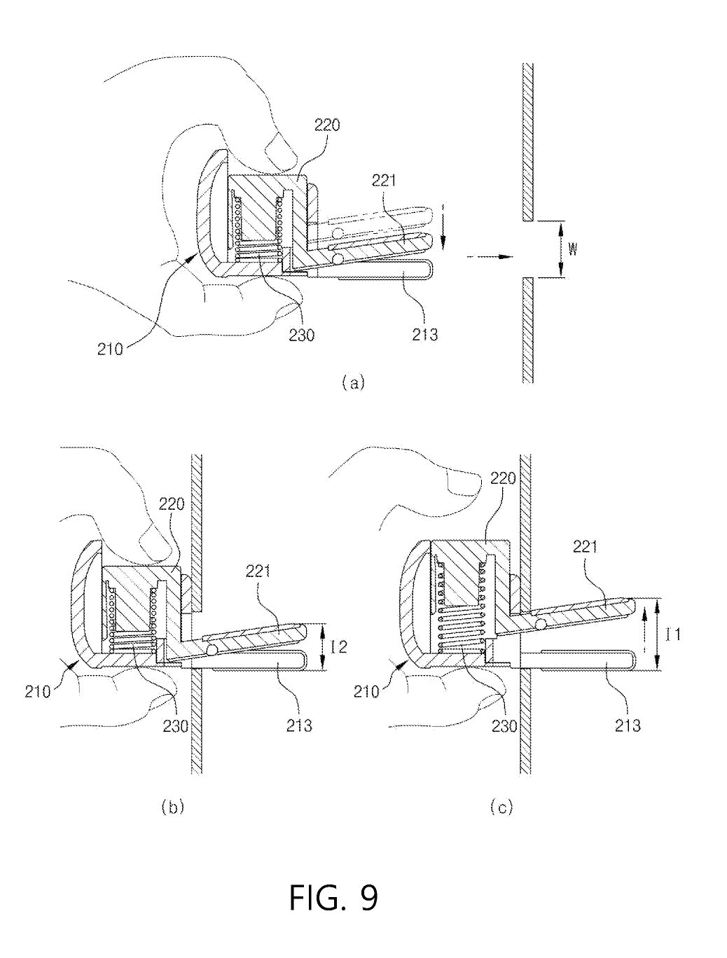

Referring to FIG. 9, the upper fixing wing 221 of the button body 220 is manufactured to have a shape that is inclined upward so as to allow the gap I1 between the upper fixing wing 221 and the lower fixing wing 213, which is fixed by elastic restoring force of the spring 230, to be greater than the width W of the CD slot in the vehicle, thereby preventing the mobile device mount for a CD slot according to the present invention from being withdrawn from the CD slot in the vehicle.

In the present embodiment, the number of lower fixing wings 213 connected to the mounting body 210 is two and the number of upper fixing wings 221 of the button body 220 is two, but the number of lower fixing wings and the number of upper fixing wings may be optionally changed to various numbers such as three or four, respectively, in accordance with the size of the mobile device mount for a CD slot according to the present invention. The same applies to the aforementioned second biasing members 230.

Referring to FIGS. 4-6 and 9, the button body 220 also includes an inner housing 223 for securing the second biasing member 230. The inner housing 223 includes a pair of guide protrusions 223a protruding from an interior of the button body 220 in which the spring 230 is accommodated, and the second biasing member 230 is fitted with the protruding guide protrusion 223, such that the second biasing member 230 may be compressed and restored without being bent by exerted force.

Referring to FIG. 9, in operation, the button body 220 on the outer housing 210, which constitutes the fixing member 200 for a CD slot, is first pushed, and as a result, the button body 220 is moved downward while the second biasing member 230 provided in the button body 220 is elastically compressed (as shown in “(a)”). In turn, the upper fixing wing 221 connected to the back side of the button body 220 is also moved downward. As a result, the gap 12 between the upper fixing wing 221 of the button body 220 and the lower fixing wing 213 of the outer housing 210 becomes smaller than the width W of the CD slot in the vehicle, such that the upper fixing wing 221 and the lower fixing wing 213 may freely enter the CD slot in the vehicle (as shown in “(b)”). Thereafter, when the exerted external force is eliminated, the elastically compressed second biasing member 230 is elastically restored, and the button body 220 is also moved upward in conjunction with the restoration of the second biasing member 230. In this case, the upper fixing wing 221 connected to the back side of the button body 220 is also moved upward, and the gap I1 between the upper fixing wing 221 of the button body 220 and the lower fixing wing 213 of the outer housing 210 becomes greater than the width W of the CD slot in the vehicle, thereby preventing the mobile device mount for a CD slot according to the present invention from being withdrawn (as shown in “(c)”). Since the upper fixing wing 221, which has been moved upward and is inclined upward, the upper fixing wing 221 guides the mobile device mount for a CD slot according to the present invention so that the mobile device mount may be securely fixed to the CD slot in the vehicle without swaying.

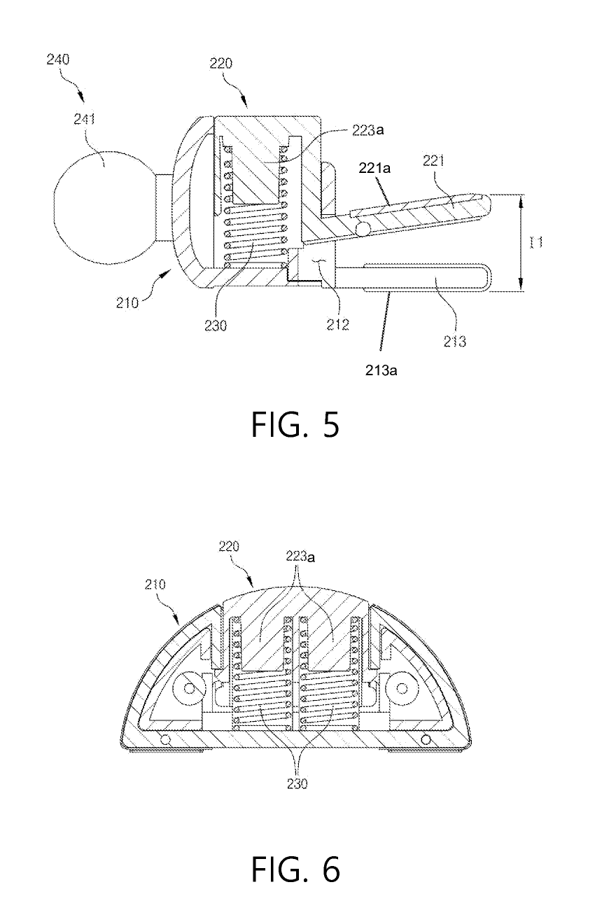

Referring to FIGS. 5, 8 and 10, to adjust an angle of the mobile device mounting member 100 connected to the fixing member 200 for a CD slot to various angles, that is, to an omnidirectional angle based on a location where a user is positioned, a first attachment member 150 having a connecting space 151 is provided at a back side of the mobile device mounting member 100, and a second attachment member 240 having a ball 241 is provided on the fixing member 200 for a CD slot, such that the ball 241 is connected by being accommodated in the connecting space 151 of the first attachment member 150. In this configuration, the mounting member 100 is rotatable 360 degrees in a parallel plane of motion with respect to the fixing member 200 and also adjustable to different angles to different planes of motion. Thus, the mounting member could be used with the first and second holding arms 140, 112 positioned vertically, horizontally or at any angle therebetween depending on, for example, whether the first and second holding arms 140, 112 will interfere with instrumentalities of the mobile device or vehicle dashboard. Furthermore, the fixing member 220 could be used upside down from the description and figures herein based on convenience. For example, the user could attach the fixing member 220 to the CD slot in a particular desired configuration to prevent the outer housing 210 from impeding the user's view of any instruments on the vehicle's dashboard.

The present embodiments may have other specific forms without departing from its spirit or essential characteristics. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A holder for a portable device, comprising:
a mounting member comprising:
a mount body having a first holding arm opposite a second holding arm and an intermediate section therebetween;
a support rod assembly having first and second ends, the support rod assembly first end coupled to the first holding arm;
a biasing member having first and second ends, the biasing member first end coupled to the support rod assembly second end; and
a support shaft coupled to the mount body intermediate section, the biasing member second end coupled to the support shaft.

2. The holder of claim 1, wherein the support shaft, biasing member and support rod assembly are enclosed within the mount body when the mounting member is in a rested state.

3. The holder of claim 1, wherein the biasing member is extended when the first holding arm is moved away from the intermediate section in an engaged state.

4. The holder of claim 1, further comprising a fixing member operably coupled to the mounting member, the fixing member configured to be fixed to an object.

5. The holder of claim 1, wherein the biasing member is a flat, flexible material such that the biasing member is rolled and circumscribes the support shaft.

6. The holder of claim 1, wherein the support rod assembly comprises:
opposing longitudinal rods extending from the first holding arm at the support rod assembly first end; and
a transverse rod coupling the opposing longitudinal rods at the support rod assembly second end;
wherein the biasing member first end is coupled to the transverse rod.

7. A holder for a portable device, comprising:
a fixing member comprising:
an outer housing having upper and lower ends, a space extending between the outer housing upper and lower ends, a lower fixing wing extending from the housing;
a button body having upper and lower ends, an upper fixing wing extending from the button body, the upper fixing wing positioned above the lower fixing wing at a first vertical distance in a rested state; and
a biasing member, the biasing member coupled to the outer housing;
wherein the button body is secured within the outer housing space and the biasing member engages the outer housing and button body.

8. The holder of claim 7, wherein the outer housing further comprises a lower housing extending downwardly from the button body lower end, the biasing member being positioned therein.

9. The holder of claim 7, wherein the upper fixing wing and the lower fixing wing are positioned at a second vertical distance apart from each other in an engaged state, the second vertical distance being less than the first distance.

10. The holder of claim 9, wherein the upper fixing wing includes a pair of first extensions and the lower fixing wing includes a pair of second extensions, wherein the pair of first extensions are positioned between the pair of second extensions in the engaged state.

11. The holder of claim 7, wherein the outer housing further comprises an inner wall extending downwardly from the outer housing upper end, the inner wall having a free end at a distal end thereof.

12. The holder of claim 10, wherein the button body further comprises a tab extending laterally outwardly from a lower end thereof such that the tab engages the inner wall distal end of the outer housing.

13. The holder of claim 7, further comprising a mounting member, the mounting member configured to hold the portable device.

14. The holder of claim 13, wherein the mounting member comprises a magnetic surface.

15. A holder for a portable device comprising:
a mounting member comprising:
a mount body having an first holding arm opposite a second holding arm and an intermediate section therebetween;
a support rod assembly having first and second ends, the support rod assembly first end coupled to the first holding arm;
a first biasing member having first and second ends, the first biasing member first end coupled to the support rod assembly second end; and
a support shaft coupled to the mount body intermediate section, the first biasing member second end coupled to the support shaft; and
a first attachment member extending from a rear portion of the mount body; and
a fixing member comprising:
an outer housing having upper and lower ends, a space extending between the outer housing upper and lower ends, a lower fixing wing extending from the outer housing;
a button body having upper and lower ends, an upper fixing wing extending from the button body, the upper fixing wing positioned above the lower fixing wing at a first vertical distance in a rested state;
a second biasing member, the second biasing member coupled to the outer housing, wherein the button body is secured within the outer housing space and the second biasing member engages the outer housing and button body; and
a second attachment member extending from a front portion of the outer housing;
wherein the first and second attachment members are engaged such that mounting member and fixing member are operably coupled together.

16. The holder of claim 15, wherein the first biasing member is a flat, flexible material such that the first biasing member is rolled and circumscribes the support shaft.

17. The holder of claim 16, wherein the first biasing member is extended when the first holding arm is moved away from the intermediate section in an engaged state.

18. The holder of claim 15, wherein the support rod comprises:
opposing longitudinal rods extending from the first holding arm at the support rod first end; and
a transverse rod coupling the opposing longitudinal rods at the support rod second end;
wherein the first biasing member first end is coupled to the transverse rod.

19. The holder of claim 15, wherein the upper fixing wing and the lower fixing wing are positioned at a second vertical distance apart from each other in an engaged state, the second vertical distance being less than the first distance.

20. The holder of claim 14, wherein the mounting member is rotatable 360 degrees with respect to the fixing member.
